(19) United States
(12) Patent Application Publication
(10) Pub. No.: US 2016/0347438 A1
(43) Pub. Date: Dec. 1, 2016

(54) SINGLE-PIECE STRINGER FOR AERONAUTIC STRUCTURE

(71) Applicant: STELIA AEROSPACE, Rochefort (FR)

(72) Inventors: Nicolas Kawski, Saint Loup Cammas (FR); Olivier Vincent, Cornebarrieu (FR)

(73) Assignee: STELIA AEROSPACE, Rochefort (FR)

(21) Appl. No.: 15/166,763

(22) Filed: May 27, 2016

(30) Foreign Application Priority Data
May 29, 2015 (FR) 1554842

(51) Int. Cl. B64C 1/06; B64C 3/18

(52) U.S. Cl. CPC B64C 1/064; B64C 3/182; B64C 2001/0081

(57) ABSTRACT

The invention relates to a single-piece stringer for an aeronautic structure, the stringer comprising a single-piece body including at least one hollow longitudinal portion so as to define an outer enclosure, said outer enclosure including a plurality of openings.

The present invention relates to the manufacture of aeronautic structures, in particular, a part of an aircraft fuselage. Preferably, an aeronautic structure includes an outer panel and stringers in order to increase the rigidity of said panel.

The mechanical strength of such a structure must be high in order to react to various forces that pass through an aircraft during use. Furthermore, the mass of such a structure must be as low as possible in order to limit the mass of the aircraft on which the structure must be mounted.

As an example, known from patent application U.S. Pat. No. 2,170,458 A is a panel on which a plurality of stringers are fastened so as to increase its rigidity. Each stringer includes three longitudinal spars connected by elementary links so as to form a link having a substantially sinusoidal shape between two spars. Each end of an elementary link is fixed to a spar. In order to decrease the mass of the stringer, it is taught to make openings in said elementary links.

Such a stringer according to the prior art is complex to produce, given that it is necessary to secure each of the elementary links to one of the spars. This has many drawbacks in light of the number of elementary links. Furthermore, the connection of each elementary link may form a weak point of the stringer, which is another drawback. Additionally, such connections are detrimental to the overall mass of the stringer.

One of the aims of the present patent application is to propose a stringer whereof the mass and strength are optimal to form an aeronautic structure having a high rigidity while having a low mass.

### BRIEF DESCRIPTION OF THE INVENTION

To that end, the invention relates to a single-piece stringer for an aeronautic structure, the stringer comprising a single-piece body including at least one hollow longitudinal portion so as to define an outer enclosure, said outer enclosure including a plurality of openings.

The stringer according to the invention has a light structure due to the presence of openings. Furthermore, given that it is a single piece, there are advantageously no weak points related to the assembly of several parts, as is the case in the prior art. The forces are reacted optimally, which is advantageous. Furthermore, power or hydraulic cables can be placed practically in the longitudinal hollow portion of the stringer, which increases the compactness of the aeronautic structure. Additionally, owing to the openings, the passage of tools is made easier for the assembly of the stringer to a panel.

Preferably, the stringer has a tensile strength lower than 70 kN so as to be able to be used in any aeronautic structure.

Also preferably, the stringer has a flexural strength lower than 40 kN·M so as to be able to be used in an aeronautic structure.

Also preferably, the longitudinal body includes a section comprised between 50 mm² and 500 mm² so as to be able to be integrated into an aeronautic structure.

Preferably, the outer enclosure has at least two planar faces including a plurality of openings. Thus, the mass of the stringer is reduced significantly. Also preferably, said side faces are opposite one another so as to form a stringer having a symmetrical rigidity when the latter is mounted on an aeronautic structure. Preferably, the side faces opposite one another have openings that are longitudinally offset so as to improve the stability of the stringer.

According to one aspect, the outer enclosure has a polygonal cross-section so as to define a plurality of planar faces. Such planar faces make it possible to facilitate the mounting of the stringer on the panel to form an aeronautic structure.

Advantageously, said openings form a tiling such that the surface of the tiling has a substantially homogenous mechanical strength.

Preferably, said tiling has an opening rate greater than 20% so as to provide a compromise between a high mechanical strength and a low mass.

Advantageously, the body comprises a plurality of longitudinal portions and at least one junction portion connecting said longitudinal portions in order to form a large surface area to stiffen a panel, for example.

According to one preferred aspect, the stringer is completely hollow. In other words, the longitudinal portion(s) and the junction portion(s) are hollow to decrease the mass of the stringer.

Preferably, the stringer is obtained by successively adding layers of material, preferably using an additive layer manufacturing or three-dimensional printing method.

According to one preferred aspect, the stringer is made from a metal material, preferably from aluminum.

The invention also relates to a stringer module for an aeronautic structure including a plurality of single-piece stringers as previously described. Such a stringer module has a large surface in order to be able to stiffen a panel, for example.

Preferably, said single-piece stringers are connected to one another by connecting means, preferably by splice plates.

The invention also relates to an aeronautic structure comprising a panel on which at least one stringer module as previously described is fastened.

Preferably, the aeronautic structure is a part of an airplane fuselage.

### BRIEF DESCRIPTION OF THE FIGURES

The invention will be better understood upon reading the following description, provided solely as an example, and done in reference to the appended drawings, in which:

FIG. 1 is a diagrammatic illustration of an aeronautic structure according to one embodiment of the invention;

FIG. 2 is a diagrammatic illustration of a stringer;

FIG. 3 is a diagrammatic perspective illustration of one end of a stringer;

FIG. 4 is a diagrammatic illustration of a longitudinal portion of a stringer;

FIG. 5 is a diagrammatic illustration of a connection of two adjacent stringers; and

FIG. 6 is a diagrammatic illustration of a metal sheet for producing a stringer.

It must be noted that the figures describe the invention in detail to carry out the invention, said figures of course being able to be used to better define the invention if applicable.

### DETAILED DESCRIPTION OF ONE OR MORE EMBODIMENTS

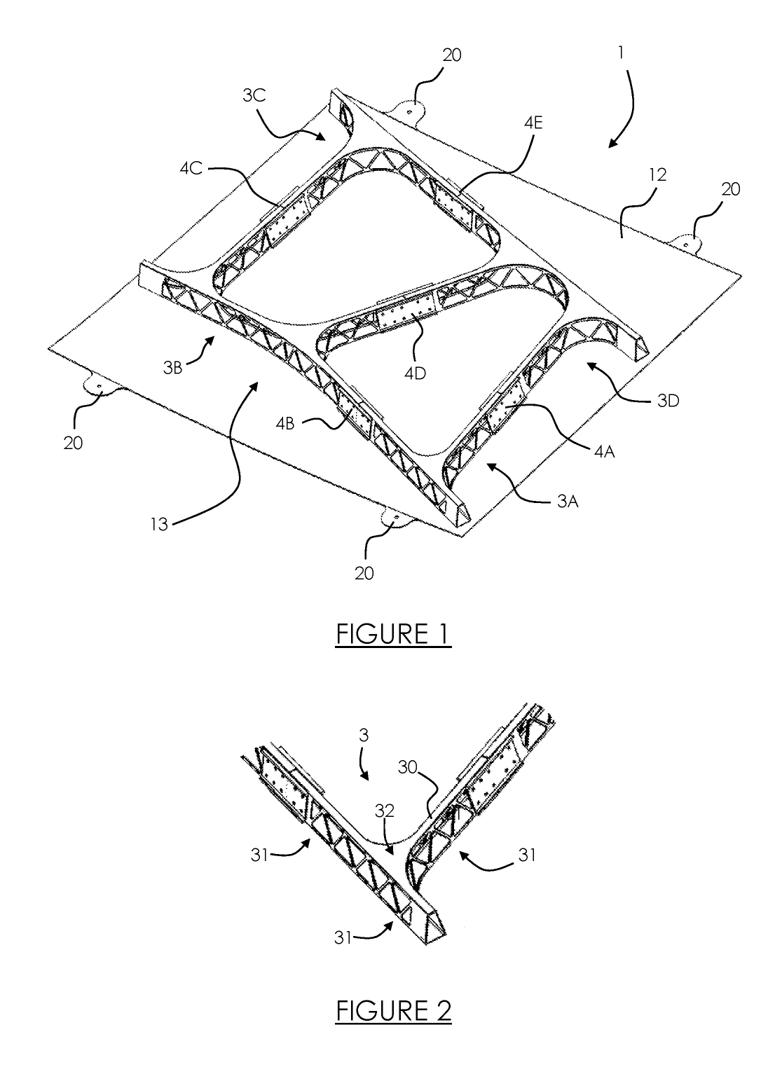

In reference to FIG. 1, an aeronautic structure is shown in one embodiment of the invention. In this example, the aeronautic structure 1 is a fuselage part of an airplane and includes a panel 12 on which a stringer module 13 is fastened using rivets. Nevertheless, other fastening means could of course also be appropriate, for example fastening by bolting or fastening by welding or gluing.

The panel 12 is preferably made from a metal material in order to benefit from a high mechanical strength. Nevertheless, a composite panel could of course also be appropriate to benefit from a reduced weight. Preferably, the panel 12 includes connecting members 20 in order to make it possible to connect several structures 1 together to form an aircraft fuselage.

Still in reference to FIG. 1, the stringer module 13 includes a plurality of single-piece stringers 3A-3D that are connected to one another using connecting means 4A-4E such that the stringer module 13 has a large surface area making it possible to stiffen the panel 12. In this example, the stringer module 13 includes four single-piece stringers 3A-3D, but of course their number could be different. Likewise, the stringer module 13 includes five single-piece stringers 4A-4E, but of course their number could be different based on the shape and number of stringers 3A-3D. The connecting means 4A-4E will be described in more detail below.

We will now describe the single-piece stringer 3A of the stringer module 13. Out of a concern for clarity and concision, the single-piece stringer is designated with numerical reference “3” in FIG. 2. The stringer 3 is described as being a single-piece stringer because it is made from a single part and is not formed by an assembly of parts, as may be the case for the stringer of patent application U.S. Pat. No. 2,170,458 A.

As illustrated in FIG. 2, the single-piece stringer 3 includes a body 30 comprising three longitudinal portions 31 connected by a junction portion 32. Of course, a single-piece stringer 3 could include a different number of longitudinal portions 31 and junction portions 32. As an example, in reference to FIG. 1, the single-piece stringer 3B includes five longitudinal portions 31 and two junction portions 32.

Preferably, the single-piece stringer 23 has a tensile strength lower than 70 kN, a flexural strength of less than 40 kN·M, and a section comprised between 50 mm² and 500 mm² so as to be able to be integrated into an aeronautic structure.

A longitudinal portion 31 is shown diagrammatically in reference to FIG. 4. The longitudinal portion 31 is hollow and has a peripheral enclosure with a polygonal section. In this example, the section of the enclosure is trapezoidal, but it may of course be different, in particular square, pentagonal or hexagonal. Of course, the section could not be polygonal and include one or more curved parts. Nevertheless, it is preferable for the section to include at least one planar face, in particular, to be fastened to the panel 12 of the structure 1. Likewise, the edges between the faces can be protruding or rounded.

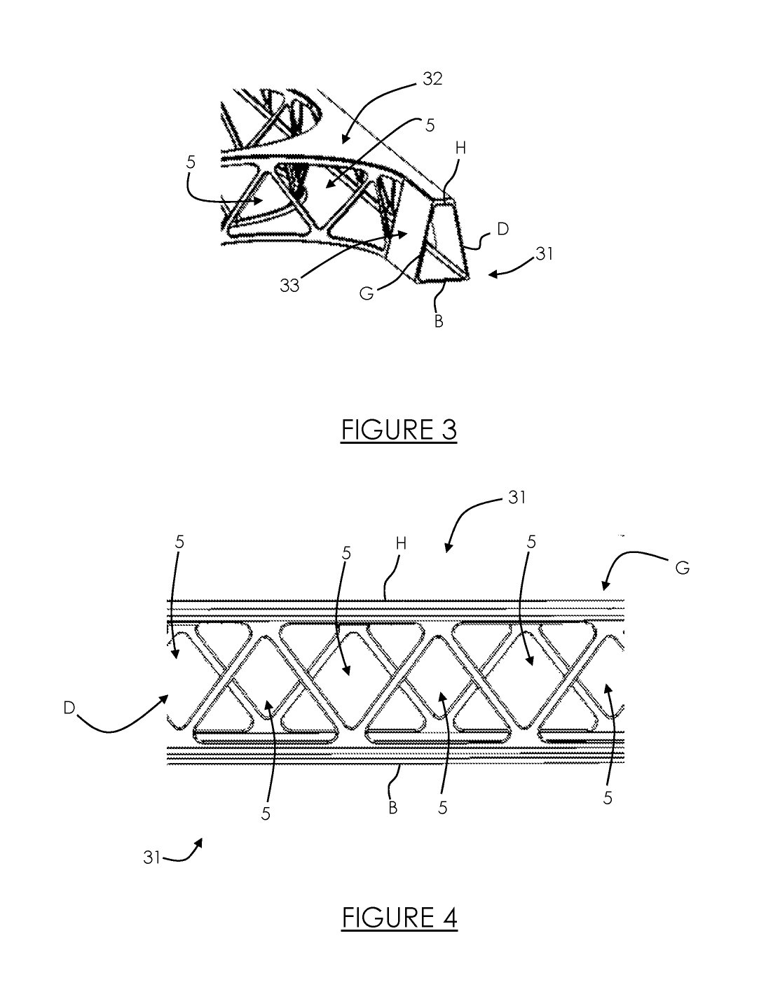

In reference to FIG. 3, the enclosure of the longitudinal portion 31 defines four side faces: a lower face B, an upper face H and two side faces G, D. Preferably, the faces are substantially planar. In this example, the lower face B is intended to be fastened to a panel 12 as illustrated in FIG. 1.

According to the invention, the enclosure of the longitudinal portion 31 includes a plurality of openings 5 in order to reduce the mass of the single-piece stringer 3 while allowing it to retain a significant rigidity at its zones that are most subject to mechanical stresses.

In this example, in reference to FIG. 4, the longitudinal portion 31 includes a plurality of openings 5 defining a same pattern, in particular a triangular pattern. Preferably, the openings 5 of the enclosure are positioned next to one another to form a tiling so as to give the zone covered by the tiling a homogenous mechanical strength. A tiling has been shown including a same pattern, but of course the tiling could comprise several different patterns. Any polygonal pattern can advantageously be appropriate.

Preferably, the opening rate of the tiling, i.e., the ratio of the open surface to the total surface of the tiling, is comprised between 10% and 99.5%, still more preferably between 20% and 99.5%, so as to provide a compromise between strength and lightness.

Still in reference to FIG. 4, the side faces G, D include openings 5, while the upper face H and the lower face B remain solid. This makes it possible on the one hand for the lower face B to be able to be easily connected to a panel 2, for example by riveting, and on the other hand for the upper face H to be able to be connected easily to a trim element of the aircraft (cover panel, etc.).

Preferably, the side faces G, D opposite one another have openings 5 that are offset. In other words, the openings 5 of one side face G are not longitudinally aligned with the openings 5 of the side face opposite it so as to increase the mechanical rigidity.

Preferably, all of the longitudinal portions 31 of a single-piece stringer 3 are hollow. Also preferably, the junction portions 32 are also hollow so as to form a completely hollow single-piece stringer 3 with a lower mass. In reference to FIG. 3, similarly to a longitudinal portion 31, a junction portion 32 includes side faces including openings 5 and, preferably, an upper face and a lower face that remain solid. The side faces of a junction portion 32 are generally curved so as to connect the side faces D, G of longitudinal portions 31 extending in different directions, as illustrated in FIG. 1. Also preferably, the side faces of a junction portion 32 also include a tiling of openings 5.

Preferably, each single-piece stringer 3 is made using a 3D printing method, preferably through a method known by those skilled in the art as additive layer manufacturing. According to such a method, layers of metallic powder are successively deposited, each layer being fused to the preceding layer, for example by a laser beam or an electron beam.

Preferably, the single-piece stringer 3 is made from aluminum, steel or stainless steel. Such a manufacturing method offers great freedom of design and makes it possible to obtain varied and complex shapes.

Alternatively, each single-piece stringer 3 is made from a method of bending a metal sheet, preferably made from aluminum or steel. In reference to FIG. 6, a planar metal sheet is machined so as to form a plurality of openings 5 in the side faces D, G of the longitudinal portion 31 of the stringer 3. Next, the metal sheet is bent along several bend lines L1, L3 in order to shape the stringer 3. The free edges of the metal sheet are next fastened together to form a peripheral enclosure. The connection is preferably made by welding, but of course other methods could be appropriate. Such a manufacturing method makes it possible to obtain stringers 3 with large dimensions for a limited cost.

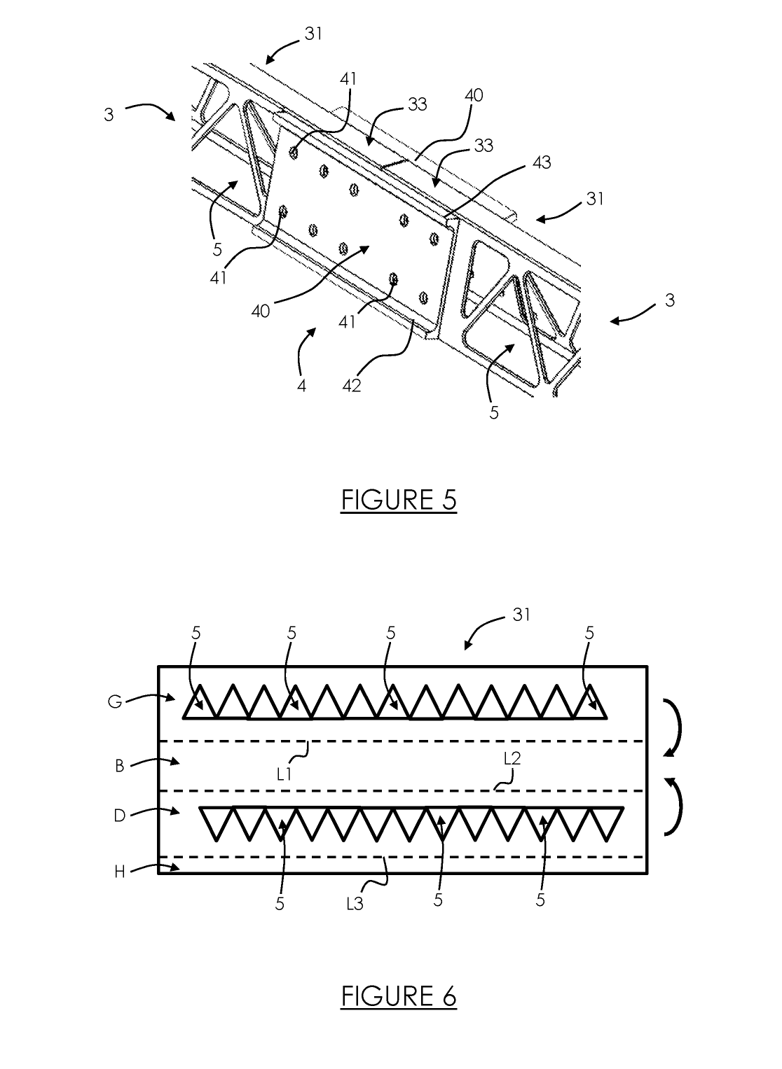

We will now describe the connecting means 4A. For reasons of clarity and concision, the connecting means 4A are designated using reference number 4 in FIG. 5.

As illustrated in FIGS. 1 and 5, two adjacent stringers 3 are connected together by connecting means 4. More specifically, the connecting means 4 make it possible to connect two free ends 33 of the longitudinal portion 31 of the stringer 3. To that end, each free end 33 of a longitudinal portion 31 of a stringer 3 includes an enclosure whereof the side faces G, D are solid as illustrated in FIG. 3 so as to allow the fastening of the connecting means 4.

In this example, in reference to FIG. 5, the connecting means 4 assume the form of two plates 40, also called splice plates, mounted opposite one another on the solid side faces G, D of the free end 33 of the longitudinal portion 31 of the stringers 3. Each plate 40 has a rectangular shape and includes two thickened longitudinal edges 42, 43 so as to increase its mechanical strength. Each plate 40 also includes a plurality of orifices 41 intended to allow the passage of fastening members (screws, rivets, etc.) through the plate 40 to reach one of the solid side faces G, D of the stringers 3. In other words, each plate 40 makes it possible to secure two aligned side faces G, D together as shown in FIG. 5.

Of course, other connecting means 4 could be appropriate, for example a connection by overlapping, a connection by gluing or by welding. Of course, a stringer module could be made in the form of a single-piece stringer if its dimensions are not too large.

To form the stringer module 13 of FIG. 1, it suffices to individually manufacture each stringer 3 as previously described and connect them together using plates 40. The stringer module 13 then assumes the form of a frame having a large surface and a small mass. Preferably, the stringer module 13 can be planar or curved as needed. In this case, one or more junction portions 32 and/or one or more longitudinal portions 31 are curved.

To form an aeronautic structure 1, in particular a fuselage part of an aircraft, the solid lower faces B of the stringer module 13 are placed against the panel 12, then are fixed to said panel 12, in particular using rivets.

The obtained fuselage part has an optimal mechanical strength for a reduced mass, which makes it possible to obtain an aircraft having a limited fuel consumption. Furthermore, power or hydraulic cables can be placed practically in the hollow longitudinal portion 31 of the stringers 3, which increases the compactness of the fuselage part. Furthermore, owing to the openings, the passage of tools is facilitated for the assembly of the stringer module 13 to a panel 12.

Lastly, the method for manufacturing each stringer 3 and the method for assembling an aeronautic structure 1 are quick to implement and offer great reliability, which is advantageous.

1. A single-piece stringer for an aeronautic structure, the stringer comprising a single-piece body including at least one hollow longitudinal portion so as to define an outer peripheral enclosure, having a polygonal cross-section so as to define a plurality of planar faces, said outer enclosure including a plurality of openings.

2. The stringer according to claim 1, wherein the outer enclosure has at least two planar faces including a plurality of openings.

3. The stringer according to claim 1, wherein said openings form a tiling.

4. The stringer according to claim 3, wherein said tiling has an opening rate greater than 20%.

5. The stringer according to claim 1, wherein the body comprises a plurality of longitudinal portions and at least one junction portion connecting said longitudinal portions.

6. The stringer according to claim 1, which is obtained by successively adding layers of material.

7. The stringer according to claim 1, which is made from a metal material, preferably from aluminum.

8. A stringer module for an aeronautic structure including a plurality of single-piece stringers according to claim 1.

9. An aeronautic structure comprising a panel on which at least one stringer module according to claim 8 is fastened.
